(19) United States
(12) Patent Application Publication
(10) Pub. No.: US 2006/0076748 A1
(43) Pub. Date: Apr. 13, 2006

(54) Wheelchair with damping mechanism

(75) Inventors: Darryl R. Pauls, Visalia, CA (US); Samuel D. Traxinger, Fresno, CA (US)

Correspondence Address: MACMILLAN SOBANSKI & TODD, LLC;ONE MARITIME PLAZA FOURTH FLOOR, 720 WATER STREET, TOLEDO, OH, 43604-1619, US

(73) Assignee: Sunrise Medical HHG Inc.

(21) Appl. No.: 11/246,493

(22) Filed: Oct. 7, 2005

Related U.S. Application Data
(60) Provisional application No. 60/617,525, filed on Oct. 8, 2004.
(60) Provisional application No. 60/621,272, filed on Oct. 22, 2004.
(60) Provisional application No. 60/621,432, filed on Oct. 22, 2004.

(51) Int. Cl. B60G 9/00

(52) U.S. Cl. 280/124.11

(57) ABSTRACT

A wheelchair has a damping system to reduce the forward pitch of the wheelchair upon sudden deceleration or upon descent of a sloped surface. The damping system includes a clamp that selectively grips a shaft.

### RELATED APPLICATIONS

This application claims priority from U.S. Provisional Patent Application Ser. No. 60/617,525, filed Oct. 8, 2004, and entitled WHEELCHAIR SUSPENSION SYSTEM. This application also claims priority from U.S. Provisional Patent Application Ser. No. 60/621,272, filed Oct. 22, 2004, and entitled WHEELCHAIR WITH TENSION MEMBER BETWEEN PIVOT ARMS. Further, this application claims priority from U.S. Provisional Patent Application Ser. No. 60/621,432, filed Oct. 22, 2004, and entitled WHEELCHAIR SUSPENSION WITH SWAYBAR.

### TECHNICAL FIELD

This invention relates to suspension systems for wheelchairs and other personal mobility vehicles.

### BACKGROUND OF THE INVENTION

Wheelchairs are designed to provide mobility for physically challenged users. Power wheelchairs generally include a base frame supported on the ground by a combination of drive wheels and idler, caster or anti-tip wheels. Mounted on the base frame are a seat and a seat back for supporting the wheelchair user. Power wheelchairs are provided with a suspension system to cushion the wheelchair user from an uneven supporting surface and thereby provide a smooth ride for the user. When a wheelchair is provided with a suspension system, sudden acceleration or deceleration of the wheelchair in any direction can result in an undesirable pitching or swaying of the wheelchair seat and occupant. For example, if the wheelchair is suddenly decelerated by reducing the power to the drive wheel, the wheelchair seat and occupant will have a tendency to pitch forward. It would be advantageous if there could be developed a wheelchair configured to counteract pitching and swaying in response to changes in wheelchair speed.

### SUMMARY OF THE INVENTION

According to this invention there is provided a wheelchair with a damping system to reduce the forward pitch of the wheelchair upon sudden deceleration or upon descent of a sloped surface.

According to this invention there is also provided a wheelchair having a frame and a rear suspension pivotally connected to the frame, and a damping system to reduce the forward pitch of the wheelchair upon sudden deceleration or upon descent of a sloped surface. The damping system includes a clamp that selectively grips a shaft pivotally mounted on the frame, thereby modifying the damping force applied to reduce the forward pitch of the wheelchair, where the rear suspension is connected to the damping system in a manner that increases the damping force as the rear suspension system is pivoted from a neutral position upon the experiencing of forward pitch by the wheelchair.

According to this invention there is also provided a wheelchair having a frame and a rear suspension pivotally mounted to the frame, the wheelchair also having a damping system to reduce the forward pitch of the wheelchair upon sudden deceleration or upon descent of a sloped surface. The rear suspension is connected to the damping system in a manner that progressively increases the damping force as the rear suspension is pivoted from a neutral position upon the experiencing of forward pitch by the wheelchair.

According to this invention there is also provided a wheelchair with a damping system to reduce the forward pitch of the wheelchair upon sudden deceleration or upon descent of a sloped surface. The damping system is configured to progressively resist forward pitch of the wheelchair in a manner such that increased forward pitch of the wheelchair causes an increased damping force resisting forward pitch.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic elevational view of a wheelchair.

FIG. 2 is a schematic elevational view of the suspension system of the wheelchair.

FIG. 3 is a schematic elevational view of the damping mechanism of the suspension system of the wheelchair.

FIG. 4 is a schematic view in perspective of the damping mechanism, looking forward.

FIG. 5 is a schematic view in perspective of the damping mechanism, looking rearward.

FIG. 6 is an exploded perspective view of the clamp of the damping mechanism.

### DETAILED DESCRIPTION OF THE INVENTION

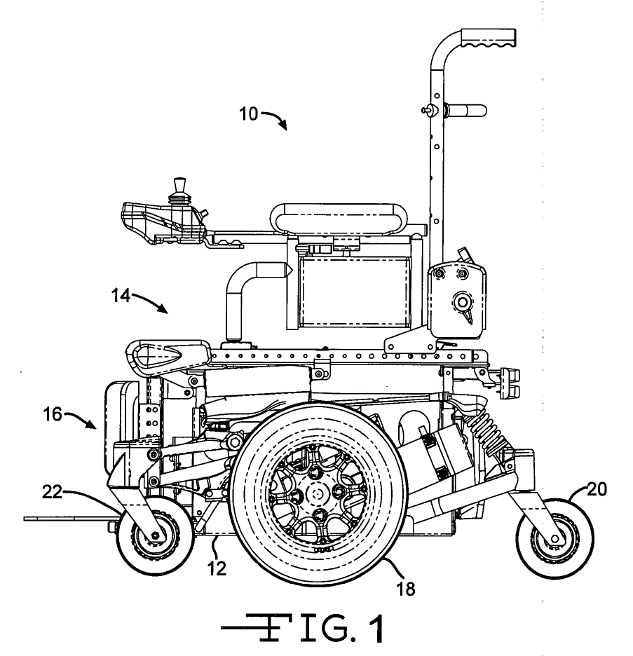

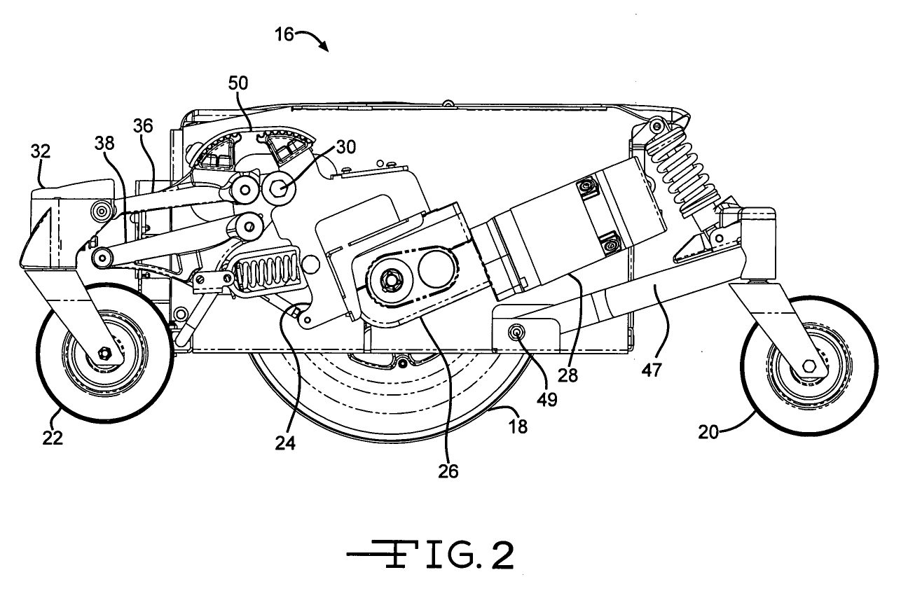

Some of the structural features of the suspension and the wheelchair itself are shown in FIGS. 1-3. As shown in FIG. 1, the wheelchair 10 includes a frame 12 on which is mounted the seat 14. The suspension 16 provides a mounting of the midwheel drive wheels 18, one more rear caster wheels 20, which can also be anti-tip wheels, and one or more front caster wheels 22 to the frame 12 As shown in FIG. 2, the wheelchair suspension includes a drive wheel pivot arm 24 on which is mounted the gearbox 26, motor 28, and the drive wheel 18 (not shown in FIG. 2, but mounted from the gear box). The drive wheel pivot arm 24 is mounted to pivot at a pivot point 30, which is fixed with respect to the frame 12. This enables the drive wheel pivot arm 24, and hence the drive wheel 18, to move up and down with respect to the frame 12 to provide a smooth ride for the wheelchair user, even when the surface underlying the wheelchair is uneven. It also enables the mid-wheel drive wheelchair to negotiate depressions in the ground without leaving the drive wheels suspended in mid-air in a condition of no traction.

The front casters 22 are mounted in a caster housing 32, which is pivotally mounted to the frame 12 by means of a front linkage, which is optionally comprised of upper and lower linkages 36 and 38, respectively. The rear caster 20, which can be an anti-tip wheel, is pivotally mounted to the frame 12 by means of a rear pivot arm 47, which is pivotally connected to the frame 12 at pivot point 49.

An optional flexible tension belt 50 connects the drive wheel pivot arm 24 to the upper linkage 36. When the drive wheel pivot arm 24 rotates in a downward direction about pivot point 30, the tension belt 50 will be pulled in a rearward direction. The rotation of the drive wheel pivot arm 24 in the downward direction would be in a clockwise direction as viewed in the drawings, which depict the left hand side of the wheelchair. When viewing the right hand side of the wheelchair, the downward rotation of the drive wheel pivot arm 24 would be in a counterclockwise direction. Rotation of the upper caster link 38 lifts the caster housing 32 and the front caster 22 from the ground, thereby enabling the wheelchair 10 to more successfully negotiate obstacles.

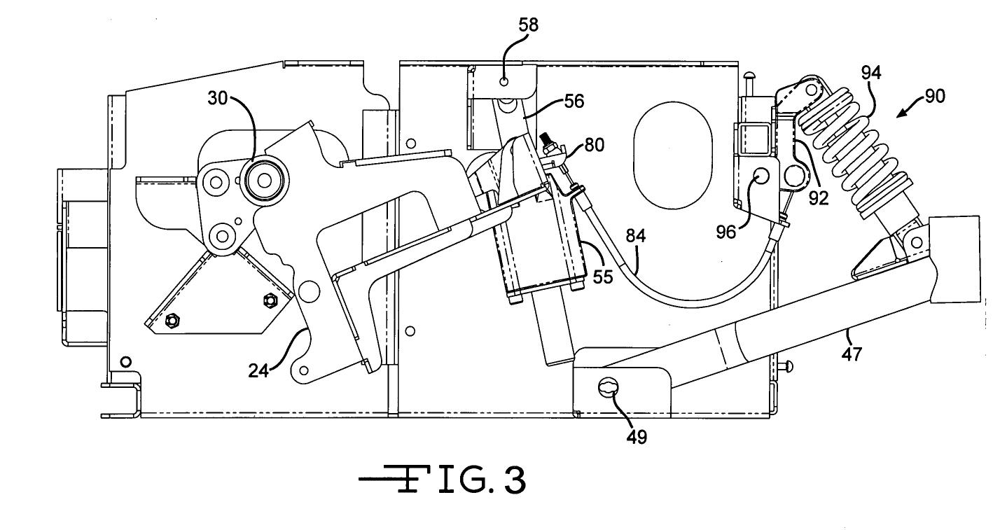

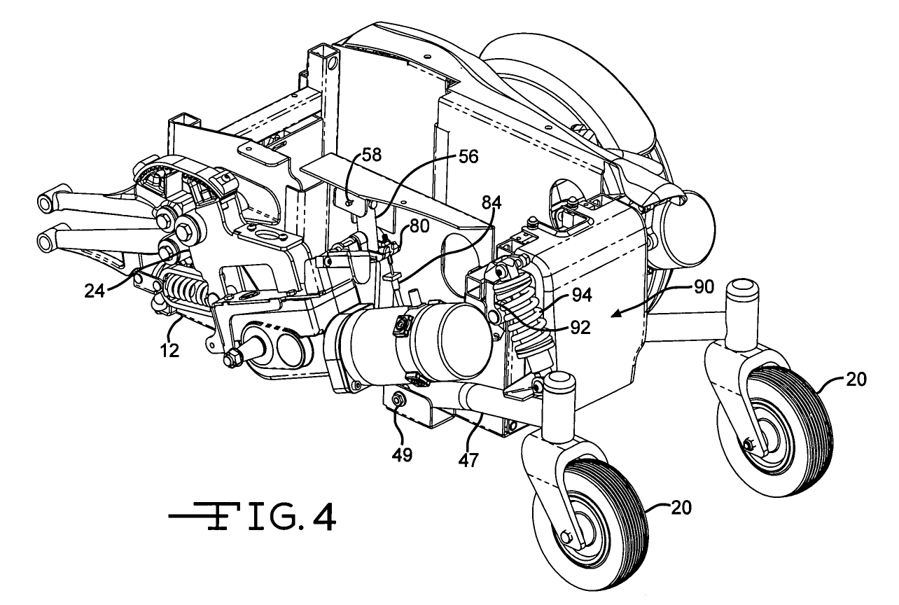

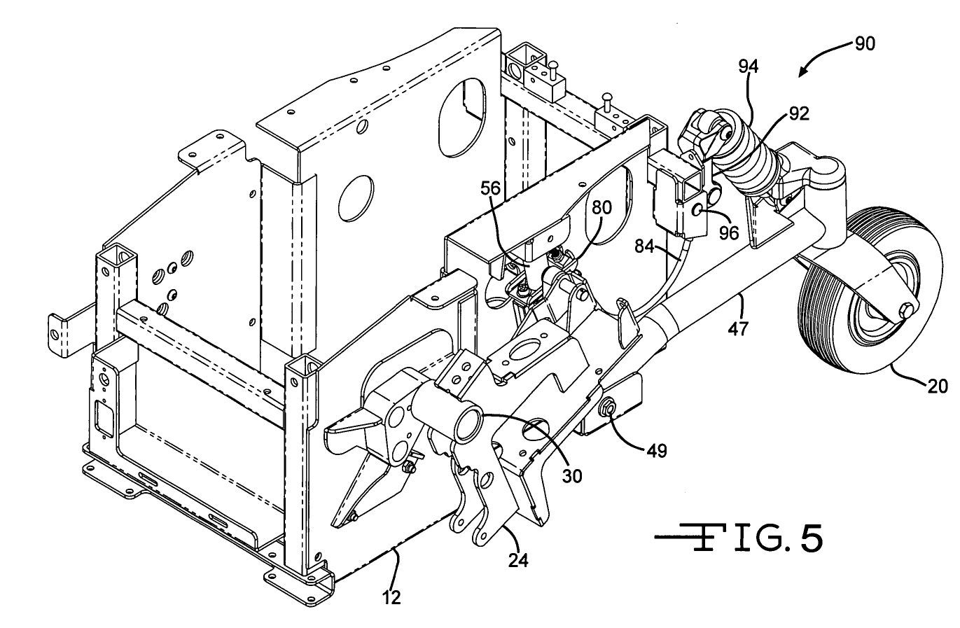

As shown in FIG. 3-5, a damping clamp 55 is pivotally attached to the drive wheel pivot arm 24, and is also mounted for sliding on a substantially vertical shaft 56. It is to be understood that if the clamp were to be attached to the drive wheel pivot arm 24 in a different place or orientation, then it could be arranged to slide on a shaft that is not vertical. FIG. 3 shows that the vertical shaft 56 is pivotally mounted from the wheelchair frame 12 at a pivot point 58. As the drive wheel pivot arm 24 pivots on its pivot axis 30, the clamp 55 slides up and down on the vertical shaft 56. If the clamp 55 were to lock on the vertical shaft 56, the drive wheel pivot arm 24 would be locked with respect to the wheelchair frame 12, and the forward pitch of the wheelchair frame 12, together with the seat 14 mounted on the frame 12, would be completely halted. Instead of having the clamp 55 lockable to the vertical shaft 56, however, the clamp is a damping clamp. The degree to which the damping clamp 55 presses the shaft 56 affects how much damping force is applied to the pivoting of the drive wheel pivot arm 24 with respect to the wheelchair frame 12. Because the clamp 55 is a damping clamp, there is never a lock between the drive wheel pivot arm 24 and the frame 12. This means that even when the damping clamp 55 is gripping tight on the vertical shaft 56, sufficient additional force on the drive wheel pivot arm 24 will cause further pitching of the wheelchair frame 12 and the seat 14 and wheelchair user supported by the frame 12.

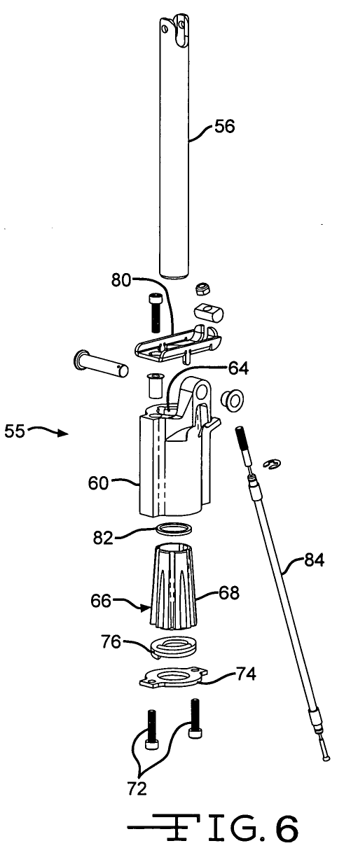

As shown in FIG. 6, the clamp 55 includes a clamp body 60, which has a frustoconical interior bore 64. Positioned within the bore 64 is a hollow insert 66 having a frustoconical outside surface 68 that substantially corresponds to the shape of the interior surface of the bore 64. As the insert 66 moves upward into the bore 64, the surface 68 engages the interior surface of the bore 64. Both the clamp body 60 and the insert 66 are positioned around the substantially vertical shaft 56, and are mounted to ride up and down on the shaft 56. The insert 66 is made of a polymer material, although any other suitable material can be used. It is to be understood that other configurations of the damping claim can be used, as long as a progressively increasing damping force can be applied.

The insert 66 is held in place by bolts 72 and bottom plate 74. Other means could also be used. A spring 76 biases the insert 66 upward into the body 60 of the clamp 55. As insert 66 is driven upward into the bore 64, the taper of the frustoconical surfaces causes the insert 66 to increase pressure against the vertical shaft 56, thereby gripping the shaft 56 with an increasing force. Increased gripping by the clamp increases the damping force of the clamp against movement of the drive wheel pivot arm. A lever 80 mounted on the top of the clamp body 60 can be pushed or forced down to move push ring 82 and the insert 66 slightly downward relative to the clamp body 60, thereby lessening the pressure of the clamp 80 on the vertical shaft 56, and consequently applying a lower damping force. This downward movement acts contrary to the upward force applied by the spring 76. The lever 80 is activated by a cable 84 to control the damping force applied by the clamp. Preferably, the clamp 80 system is configured so that the fail-safe configuration is a damped configuration, but it could be configured to be un-damped. It can be seen that the unloading of the rear suspension allows the lever 80 and ring 82 to retract and allows the spring 76 to lift the insert 66 into contact with the interior of the bore 64, thereby applying a damping force to the shaft 56.

Optionally, there are grooves on the inner and outer faces of the insert 66. These grooves are configured and arranged to allow better fit against the shaft 56, to ensure that there is more contact surface area on the inside of the insert 66 than on the outside of the insert 66, and to allow fluid egress from the damping clamp 55 in the event the damping clamp 55 becomes wet. The groove configuration of the insert 66 ensures that the insert 66 will have a higher contact load against the shaft 56 than against the inner surface of the clamp body 60. This allows the damping clamp 55 to partially release or reduce the clamping force on the shaft 56 when the wheelchair is settling back from a pitching situation prior to the occurrence of the complete unloading or releasing of the damping clamp caused by the event of having the rear suspension 90 return into contact the ground. Other surface characteristics such as orifices can be used in place of the grooves.

The damping clamp 55 is connected to the rear suspension 90 by the cable 84. More specifically, the cable 84 leads to a shock absorber mounting block 92 that is connected to the upper end of a rear shock absorber 94. The lower end of the rear shock absorber 94 is connected indirectly to the rear caster wheel 20. The shock absorber mounting block 92 is pivotally mounted for pivoting at pivot point 96. During operation of the wheelchair, the position of the rear caster wheel 20 will change relative to the frame 12 due to loads applied to the rear caster wheel 20 and also due to variations in the surface on which the wheelchair is moving. The amount of damping force that is applied to the shaft 56 is a function of the position of the rear suspension 90 relative to the frame 12, as well as of the amount of spring preload selected on the damping clamp 55. It can be seen that the clamp 55 selectively grips the shaft. As the insert 66 is allowed to move up into the clamp body 60 by the action of the spring 76, the grip or damping force of the clamp 55 on the shaft 56 progressively increases. The specific amount of gripping force at any moment is selected by the action of the rear suspension 90. The adjustment of the cable 84 determines the point at which the damping becomes effective, i.e., the point at which the clamp 55 begins to clamp, as initiated by the position of the rear suspension 90.

In a normal equilibrium state, such as when the wheelchair is traveling on level ground, the rear shock absorber 94 pushes up on the shock absorber mounting block 92. As the upward load on the rear suspension 90 becomes diminished, such as would occur upon a sudden braking action, the rear shock absorber 94 extends or hangs from the shock absorber mounting block 92. This causes the shock absorber mounting block 92 to rotate about its pivot axis 96, releasing tension on the connecting cable 84 and allowing the lever 80 and ring 82 to retract. When this happens, the spring 76 will lift the insert 66 into greater contact with the interior of the bore 64. This provides increased force on the shaft 56, and a resultant damping of movement of the clamp 55 relative to the shaft 56 and relative to the wheelchair frame 12. This allows a more restrictive movement, i.e., less free movement, of the drive wheel pivot arm 24, and hence the drive wheel 18, with respect to the frame 12. As mentioned above, even though movement is more restricted, relative movement is not totally prevented since sufficient additional force on the drive wheel pivot arm 24 will cause further pitching of the wheelchair frame 12. It can be seen that the rear suspension 90 is connected to the damping system in a manner that progressively increases the damping force as the rear suspension 90 is pivoted from a neutral position upon the experiencing of forward pitch by the wheelchair.

In another embodiment of the invention, pitch reduction in the wheelchair can be controlled via a sensing or sensor electrical switching method. A sensor, not shown, is attached to the rear suspension 90, such as to the rear shock absorber 94. During forward pitch of the wheelchair, the forces of the forward pitching tend to lift the rear suspension 90 so that it pivots on the pivot point 49. An electromechanical damping unit, not shown, is pivotally connected between the drive wheel pivot arm 24 and the wheelchair frame 12. As the rear suspension 90 unloads, indicating a pitching situation, the sensor or switching device is configured to send a signal to the electro-mechanical damping unit to increase the amount of damping force applied to the suspension system, thereby reducing pitching.

While the description above has primarily focused on forward pitching, the invention can also be used to counteract rearward pitching, as will be appreciated by those skilled in the art.

The principle and mode of operation of this invention have been described in its preferred embodiments. However, it should be noted that this invention may be practiced otherwise than as specifically illustrated and described without departing from its scope.

What is claimed is:

1. A wheelchair with a damping system to reduce the forward pitch of the wheelchair upon sudden deceleration or upon descent of a sloped surface.

2. The wheelchair of claim 1 in which the damping system includes a clamp that selectively grips a shaft, thereby modifying the damping force applied to reduce the forward pitch of the wheelchair.

3. The wheelchair of claim 2 in which the shaft is a substantially vertical shaft.

4. The wheelchair of claim 2 in which the shaft is pivotally mounted on a frame of the wheelchair.

5. The wheelchair of claim 2 in which the clamp includes a clamp body having a frustoconical interior bore, and a hollow insert having a frustoconical outside surface that substantially corresponds to the shape of an interior surface of the bore, with both the clamp body and the insert being positioned around the shaft, and with both the clamp body and the insert being mounted to ride up and down on the shaft, with the insert and the clamp body being configured so that as the insert moves upward into the bore, the outside surface of the insert engages the interior surface of the bore, thereby increasing the grip of the clamp on the shaft.

6. The wheelchair of claim 5 in which there are grooves on inner and outer faces of the insert.

7. The wheelchair of claim 2 in which the wheelchair includes a rear suspension pivotally connected to a frame of the wheelchair, with the rear suspension being connected to the damping system in a manner that increases the damping force as the rear suspension system is pivoted from a neutral position upon the experiencing of forward pitch by the wheelchair.

8. The wheelchair of claim 7 in which a cable connects the rear suspension with the clamp.

9. The wheelchair of claim 2 in which the damping system has a fail safe configuration that is a damping configuration.

10. The wheelchair of claim 1 in which the damping system includes an electromechanical damping unit.

11. The wheelchair of claim 1 in which the damping system includes a sensor attached to a rear suspension of the wheelchair.

12. The wheelchair of claim 1 in which the damping system has a fail safe configuration that is a damping configuration.

13. A wheelchair having a frame and a rear suspension pivotally connected to the frame, and a damping system to reduce the forward pitch of the wheelchair upon sudden deceleration or upon descent of a sloped surface, the damping system including a clamp that selectively grips a shaft pivotally mounted on the frame, thereby modifying the damping force applied to reduce the forward pitch of the wheelchair, where the rear suspension is connected to the damping system in a manner that increases the damping force as the rear suspension system is pivoted from a neutral position upon the experiencing of forward pitch by the wheelchair.

14. The wheelchair of claim 13 in which the clamp includes a clamp body having a frustoconical interior bore, and a hollow insert having a frustoconical outside surface that substantially corresponds to the shape of an interior surface of the bore, with both the clamp body and the insert being positioned around the shaft, and with both the clamp body and the insert being mounted to ride up and down on the shaft, with the insert and the clamp body being configured so that as the insert moves upward into the bore, the outside surface of the insert engages the interior surface of the bore, thereby increasing the grip of the clamp on the shaft.

15. A wheelchair having a frame and a rear suspension pivotally mounted to the frame, the wheelchair also having a damping system to reduce the forward pitch of the wheelchair upon sudden deceleration or upon descent of a sloped surface, where the rear suspension is connected to the damping system in a manner that progressively increases the damping force as the rear suspension is pivoted from a neutral position upon the experiencing of forward pitch by the wheelchair.

16. The wheelchair of claim 15 in which a cable connects the rear suspension with the clamp.

17. A wheelchair with a damping system to reduce the forward pitch of the wheelchair upon sudden deceleration or upon descent of a sloped surface, the damping system being configured to progressively resist forward pitch of the wheelchair in a manner such that increased forward pitch of the wheelchair causes an increased damping force resisting forward pitch.

18. The wheelchair of claim 17 in which the damping system includes a clamp that selectively grips a shaft, thereby modifying the damping force applied to reduce the forward pitch of the wheelchair.

19. The wheelchair of claim 18 in which the shaft is a substantially vertical shaft pivotally mounted on a frame of the wheelchair.

20. The wheelchair of claim 19 in which the clamp includes a clamp body having a frustoconical interior bore, and a hollow insert having a frustoconical outside surface that substantially corresponds to the shape of an interior surface of the bore, with both the clamp body and the insert being positioned around the shaft, and with both the clamp body and the insert being mounted to ride up and down on the shaft, with the insert and the clamp body being configured so that as the insert moves upward into the bore, the outside surface of the insert engages the interior surface of the bore, thereby increasing the grip of the clamp on the shaft.

21. The wheelchair of claim 20 in which there are grooves on inner and outer faces of the insert.

22. The wheelchair of claim 17 in which the wheelchair includes a rear suspension pivotally connected to a frame of the wheelchair, with the rear suspension being connected to the damping system in a manner that increases the damping force as the rear suspension system is pivoted from a neutral position upon the experiencing of forward pitch by the wheelchair.

23. The wheelchair of claim 18 in which the damping system has a fail safe configuration that is a damping configuration.
